(19) United States
(12) Patent Application Publication
(10) Pub. No.: US 2026/0168544 A1
(43) Pub. Date: Jun. 18, 2026

(54) SELECTABLE ONE-WAY CLUTCH

(71) Applicant: NSK-WARNER K.K., Tokyo (JP)

(72) Inventors: Shinji OKADA, Shizuoka (JP); Xiaoming GU, Shizuoka (JP); Takuro SATO, Shizuoka (JP)

(73) Assignee: NSK-WARNER K.K., Tokyo (JP)

(21) Appl. No.: 19/395,446

(22) Filed: Nov. 20, 2025

(30) Foreign Application Priority Data
Dec. 17, 2024 (JP) 2024-220917

(51) Int. Cl. F16D 41/16

(52) U.S. Cl. CPC F16D 41/16

(57) ABSTRACT

According to an aspect, a selectable one-way clutch includes a first inner ring, a first outer ring, a shift drum, and a first selectable plate including a plate body arranged in a first direction with respect to the first outer ring, and a first cam portion that extends in a second direction and lifts a first claw member against biasing force of a first biasing member. An end portion on a radially outer side of the plate body is a first power transmission portion. A coupling portion coupled to a linear motion mechanism is formed on the shift drum. A side surface of the shift drum facing the first direction is a first pressing surface. When the shift drum is moved in the first direction, the first power transmission portion is pressed in the first direction and lifting of the first claw member by the first cam portion is released.

### CROSS-REFERENCE TO RELATED APPLICATION

The present application claims priority to and incorporates by reference the entire contents of Japanese Patent Application No. 2024-220917 filed in Japan on December 17, 2024.

### BACKGROUND

### 1. Technical Field

What is disclosed herein relates to a selectable one-way clutch.

### 2. Description of the Related Art

A selectable one-way clutch includes an inner ring and an outer ring arranged to be relatively rotatable. A plurality of tooth portions are formed on one of an outer peripheral surface of the inner ring and an inner peripheral surface of the outer ring. In addition, a plurality of claw members are provided on the other of the outer peripheral surface of the inner ring and the inner peripheral surface of the outer ring. Then, when the claw members engage with the tooth portions, the inner ring and the outer ring rotate together. In addition, the selectable one-way clutch includes an annular selectable plate, for example, as disclosed in Japanese Patent Application Laid-open No. 2020-118250 in order to separate the inner ring and the outer ring.

As details of the selectable plate of Japanese Patent Application Laid-open No. 2020-118250 below, a plate body arranged on one side in an axial direction with respect to the inner ring, a cam portion extending from an end portion on a radially outer side of the plate body toward the other side in the axial direction, and a power transmission portion extending from an end portion on a radially inner side of the plate body toward the one side in the axial direction are included. The selectable plate is arranged to be movable in the axial direction. The power transmission portion is coupled to a linear motion mechanism. Thus, a load in the axial direction that moves the selectable plate in the axial direction is transmitted to the power transmission portion. When the linear motion mechanism operates and the selectable plate moves to the other side in the axial direction, the cam portion lifts the claw member. As a result, the engagement between the claw members and the tooth portions is released.

The power transmission portion of the selectable plate of Japanese Patent Application Laid-open No. 2020-118250 extends from the plate body to the one side in the axial direction (direction opposite to that of the cam portion). Thus, the selectable one-way clutch is enlarged in the axial direction.

For the foregoing reasons, there is a need for a selectable one-way clutch that can be reduced in size in an axial direction.

### SUMMARY

According to an aspect, a selectable one-way clutch includes: a first inner ring formed in an annular shape; a first outer ring formed in an annular shape and having the first inner ring arranged inside the first outer ring; a shift drum formed in an annular shape and having the first inner ring and the first outer ring arranged inside the shift drum; and a first selectable plate that separates the first inner ring and the first outer ring from each other. A direction parallel to a rotation axis of the first inner ring is an axial direction. One side of the axial direction is a first direction. Another side of the axial direction is a second direction. A plurality of first tooth portions are formed on one of an outer peripheral surface of the first inner ring and an inner peripheral surface of the first outer ring. A first claw member that is tiltable and a first biasing member that biases the first claw member toward the first tooth portions are provided on the other of the outer peripheral surface of the first inner ring and the inner peripheral surface of the first outer ring. The first selectable plate includes an annular plate body arranged in the first direction with respect to the first outer ring, and a first cam portion that extends in the second direction from an end portion on a radially inner side of the plate body and lifts the first claw member against biasing force of the first biasing member. An end portion on a radially outer side of the plate body is a first power transmission portion that protrudes radially outward compared to an outer peripheral surface of the first outer ring. A coupling portion coupled to a linear motion mechanism is formed on an outer peripheral surface of the shift drum. A side surface of the shift drum facing the first direction is a first pressing surface facing the first power transmission portion in the axial direction. When the shift drum is moved in the first direction, the first power transmission portion is pressed in the first direction and lifting of the first claw member by the first cam portion is released.

### BRIEF DESCRIPTION OF THE DRAWINGS

FIG. 1 is a sectional view of a selectable one-way clutch of a first embodiment along a central axis;

FIG. 2 is a side view of the selectable one-way clutch of the first embodiment in a state in which a hub is removed, as viewed from a second direction;

FIG. 3 is a perspective view of a first outer ring body and the hub of the first embodiment, as viewed from the second direction;

FIG. 4 is a perspective view of a first retainer of the first embodiment as viewed from a first direction;

FIG. 5 is a sectional view of a first claw member of the first embodiment taken along a direction orthogonal to the central axis, and is specifically a sectional view taken along a line V-V in FIG. 9;

FIG. 6 is a sectional view of a hub fixing hole of the first embodiment taken along an axial direction, and is specifically a sectional view taken along a line VI-VI in FIG. 2;

FIG. 7 is a perspective view of a first selectable plate of the first embodiment as viewed from the second direction;

FIG. 8 is a sectional view of a selectable-plate spring hole of the first embodiment taken along the axial direction, and is specifically a sectional view taken along a line VIII-VIII in FIG. 2;

FIG. 9 is a sectional view of the selectable one-way clutch of the first embodiment in a torque interruption state, and is specifically a sectional view taken along a line IX-IX in FIG. 2;

FIG. 10 is a sectional view of the selectable one-way clutch of the first embodiment in a torque transmission state;

FIG. 11 is a sectional view of a selectable one-way clutch of a second embodiment taken along a central axis;

FIG. 12 is a sectional view of the selectable one-way clutch of the second embodiment taken along a rivet in an axial direction;

FIG. 13 is a sectional view of the selectable one-way clutch of the second embodiment taken along a first pin in the axial direction;

FIG. 14 is a sectional view of the selectable one-way clutch of the second embodiment taken along a fourth pin in the axial direction;

FIG. 15 is a sectional view of the selectable one-way clutch of the second embodiment taken along the axial direction in such a manner that claw portions of a first claw member and a second claw member overlap;

FIG. 16 is a sectional view of the selectable one-way clutch of the second embodiment in a state in which torque is transmitted between a first inner ring and a first outer ring; and

FIG. 17 is a sectional view of the selectable one-way clutch of the second embodiment in a state in which torque is transmitted between a second inner ring and a second outer ring.

### DETAILED DESCRIPTION

A mode for carrying out the present disclosure will be described in detail with reference to the drawings. The present disclosure is not limited by contents described in the following description. In addition, components described below include what can be easily assumed by those skilled in the art and what is substantially the same. Furthermore, the components described below can be appropriately combined.

### First Embodiment

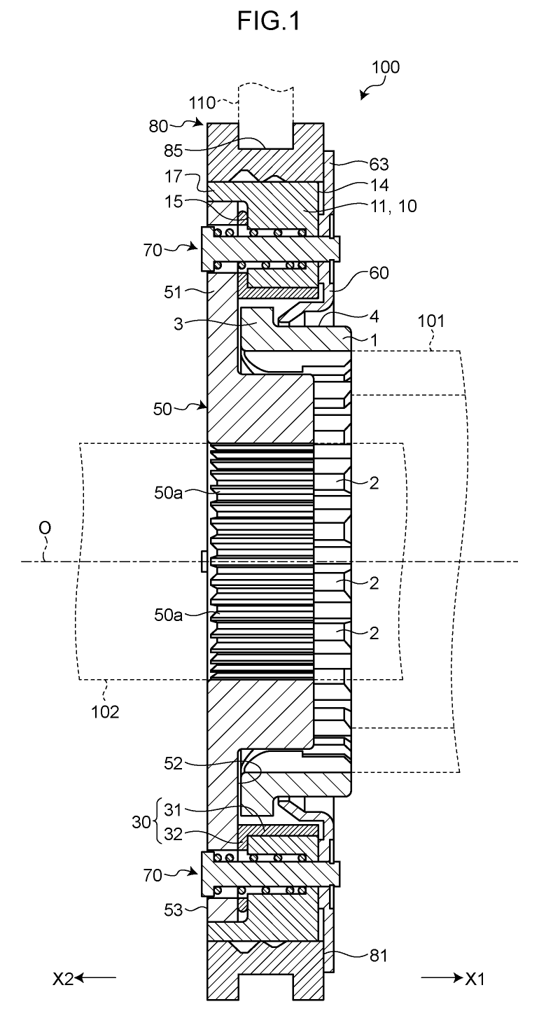

FIG. 1 is a sectional view of a selectable one-way clutch of a first embodiment along a central axis. A selectable one-way clutch 100 is a device that is arranged on a torque transmission path and that transmits or interrupts torque. Such a selectable one-way clutch 100 is used, for example, in a vehicle driving device mounted on a vehicle. The vehicle driving device is a device that generates torque by a driving source such as an engine, transmits the torque to a driving wheel, and rotates the driving wheel. The selectable one-way clutch 100 of the present disclosure may be used in a device other than the vehicle driving device.

As illustrated in FIG. 1, the selectable one-way clutch 100 is interposed between an input shaft 101 and an output shaft 102 in the present embodiment. The input shaft 101 is a cylindrical component. The output shaft 102 is arranged coaxially with the input shaft 101. In addition, a part of the output shaft 102 is arranged inside the input shaft 101.

The selectable one-way clutch 100 of the first embodiment includes a first inner ring 1, a first outer ring 10, a hub 50 arranged inside the first inner ring 1, a first selectable plate 60 that separates the first inner ring 1 and the first outer ring 10 from each other, and a shift drum 80 arranged outside the first outer ring 10.

Hereinafter, the selectable one-way clutch 100 will be described in detail, and a direction parallel to a central axis O of the first inner ring 1 is referred to as an axial direction. In the axial direction, a side on which the first selectable plate 60 is arranged when viewed from the first outer ring 10 is referred to as a first direction X1. A direction opposite to the first direction X1 is referred to as a second direction X2. A direction orthogonal to the central axis O is referred to as a radial direction.

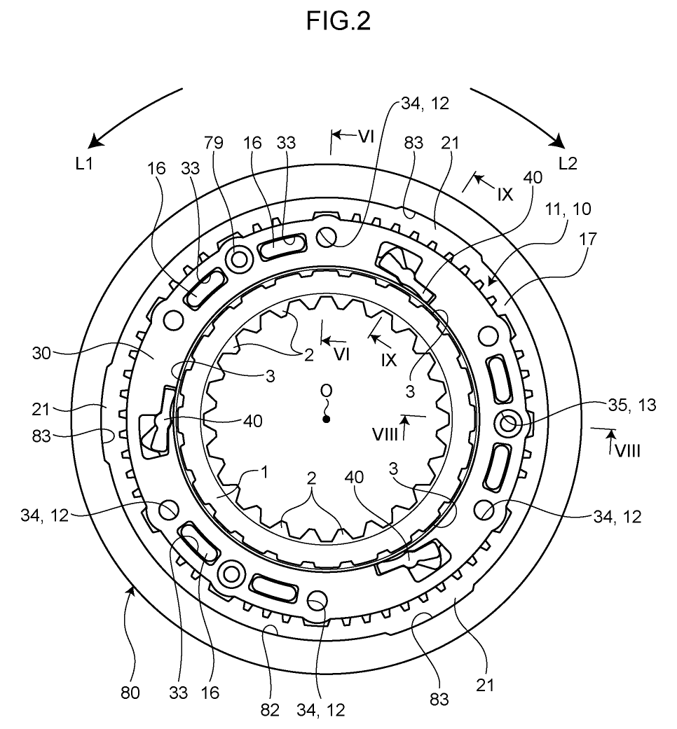

FIG. 2 is a side view of the selectable one-way clutch of the first embodiment in a state in which a hub is removed, as viewed from the second direction. A rotation direction will be described with reference to a case of being viewed from the second direction X2. A leftward rotation (counterclockwise) when viewed from the second direction X2 is referred to as a first rotation direction L1. A rightward rotation (clockwise) when viewed from the second direction X2 is referred to as a second rotation direction L2.

As illustrated in FIG. 2, the first inner ring 1 is an annular component. The input shaft 101 (see FIG. 1) is inserted inside the first inner ring 1. A plurality of female splines 2 are formed on an inner peripheral surface of the first inner ring 1. Thus, the first inner ring 1 and the input shaft 101 are spline-fitted. When the input shaft 101 rotates, the first inner ring 1 rotates about the central axis O.

A plurality of first tooth portions 3 protruding outward in the radial direction are formed on an outer peripheral side of the first inner ring 1. The plurality of first tooth portions 3 are arranged at equal intervals in a circumferential direction. As illustrated in FIG. 1, the plurality of first tooth portions 3 are formed only at an end portion in the second direction X2 of an outer peripheral surface 4 of the first inner ring 1.

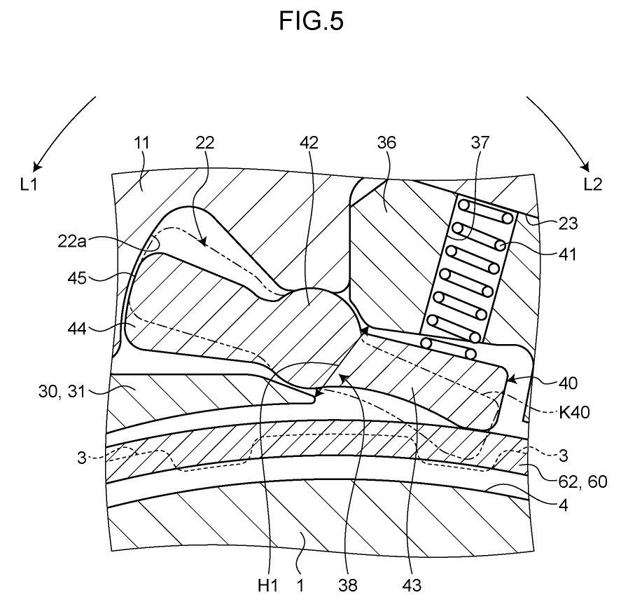

As illustrated in FIG. 2, the first outer ring 10 includes a first outer ring body 11, a first retainer 30, first claw members 40, and a first coil spring 41 (see FIG. 5 and the like).

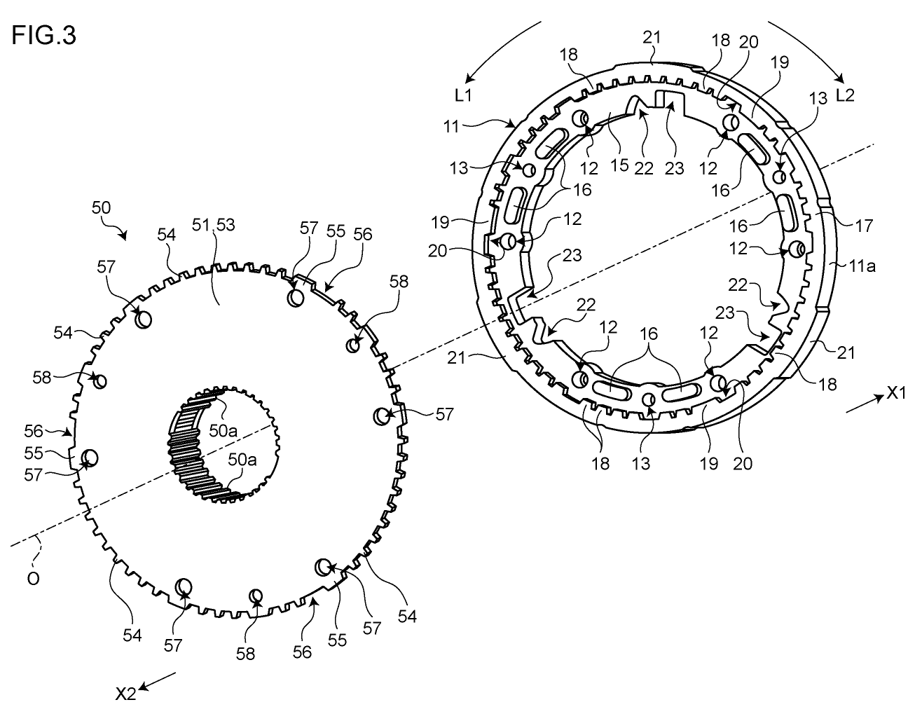

FIG. 3 is a perspective view of the first outer ring body and the hub of the first embodiment, as viewed from the second direction. As illustrated in FIG. 3, the first outer ring body 11 is an annular component and is arranged coaxially with the first inner ring 1. Six outer-ring fixing holes 12 and three outer-ring spring holes 13 are formed in the first outer ring body 11. The outer-ring fixing holes 12 and the outer-ring spring holes 13 each penetrate the first outer ring body 11 in the axial direction. The first outer ring body 11 has a first side surface 14 facing the first direction X1 (see FIG. 1) and a second side surface 15 facing the second direction X2.

A positioning protrusion 16 protruding in the second direction X2 and an annular fitting portion 17 are formed on the second side surface 15 of the first outer ring body 11. The positioning protrusion 16 is formed to be long in the circumferential direction.

The fitting portion 17 extends in the circumferential direction along an edge on the radially outer side of the second side surface 15 and is formed in the annular shape. A plurality of first triangular portions 18 protruding inward in the radial direction and three first trapezoidal portions 19 are formed on an inner peripheral side of the fitting portion 17.

A width of the first triangular portions 18 in the circumferential direction gradually decreases toward the inner side in the radial direction, and is substantially triangular when viewed along the axial direction. The first trapezoidal portions 19 have a larger width in the circumferential direction than the first triangular portions 18, and have a substantially trapezoidal shape when viewed along the axial direction.

The first triangular portions 18 are respectively arranged on both sides in the circumferential direction of each of the first trapezoidal portions 19. An interval between the first trapezoidal portion 19 and the first triangular portion 18 arranged in the first rotation direction L1 is larger than an interval between the first trapezoidal portion 19 and the first triangular portion 18 arranged in the second rotation direction L2. Thus, in the first rotation direction L1 of the first trapezoidal portion 19, a first valley portion 20 having a large interval in the circumferential direction is formed.

Three protrusion portions 21 protruding outward in the radial direction are formed on an outer peripheral surface 11a of the first outer ring body 11. The three protrusion portions 21 are arranged at intervals of 120°. A claw member housing portion 22 and a retainer housing portion 23 are formed on the inner peripheral side of the first outer ring body 11. The claw member housing portion 22 and the retainer housing portion 23 are formed by cutting out of an inner peripheral portion of the first outer ring body 11 and are opened to the inner side in the radial direction and both sides in the axial direction.

As illustrated in FIG. 1, the first retainer 30 is a component formed in an annular shape around the central axis O and has an L-shaped cross section in the axial direction. The first retainer 30 includes a body portion 31 arranged on the radially inner side of the first outer ring 10 and a side wall 32 arranged in the second direction X2 with respect to the first outer ring 10.

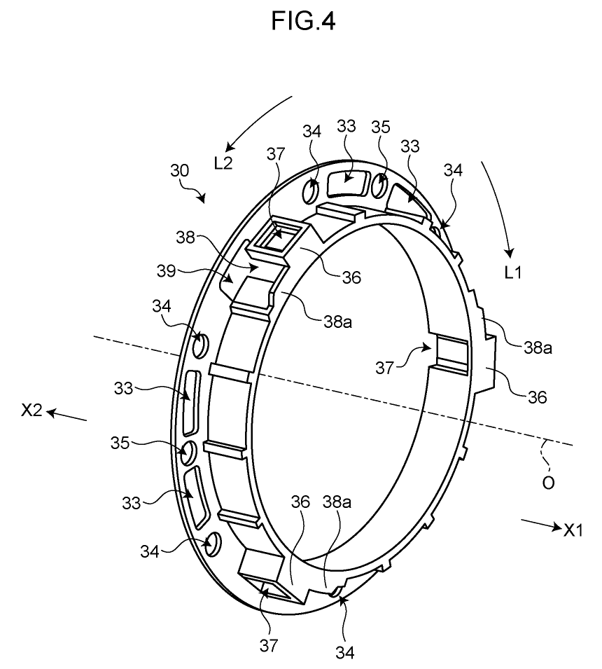

FIG. 4 is a perspective view of the first retainer of the first embodiment as viewed from the first direction. As illustrated in FIG. 4, six long holes 33 extending in the circumferential direction are formed in the side wall 32. The positioning protrusion 16 of the first outer ring body 11 is fitted into the long holes 33 (see FIG. 2).

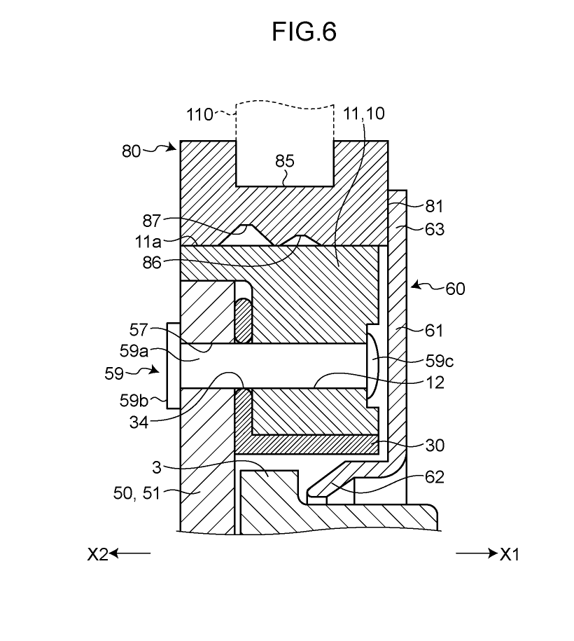

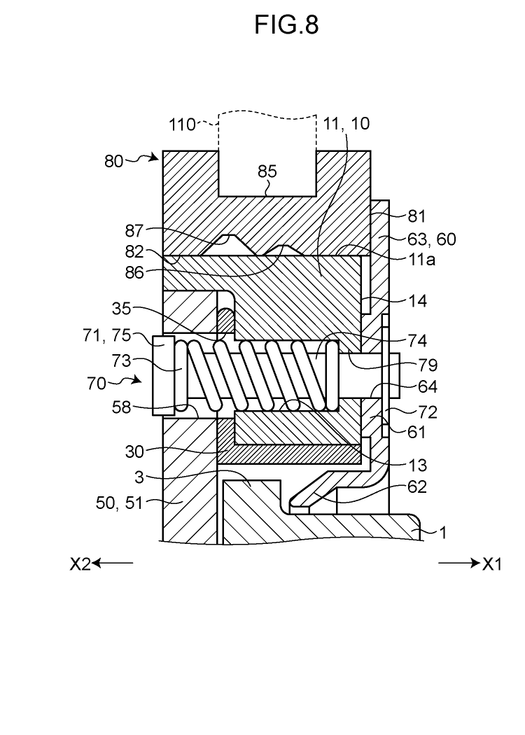

Furthermore, six retainer fixing holes 34 and three retainer spring holes 35 are formed in the side wall 32. The retainer fixing holes 34 overlap with the outer-ring fixing holes 12 of the first outer ring body 11 in the axial direction (see FIG. 6). The retainer spring holes 35 overlap with the outer-ring spring holes 13 of the first outer ring body 11 in the axial direction (see FIG. 8). Three spring holding portions 36 protruding outward in the radial direction are formed on the outer peripheral surface of the body portion 31.

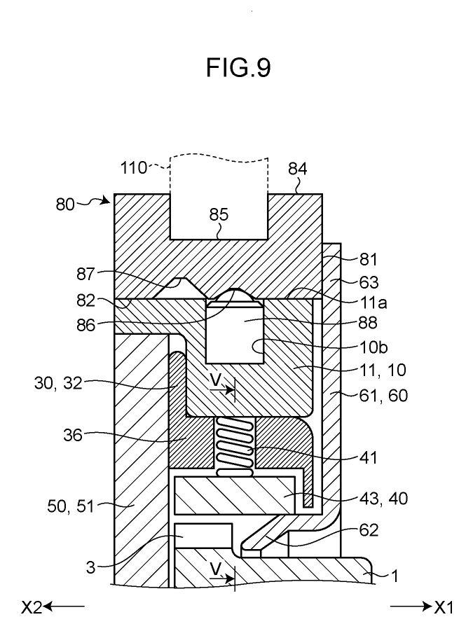

FIG. 5 is a sectional view of the first claw member of the first embodiment taken along a direction orthogonal to the central axis, and is specifically a sectional view taken along a line V-V in FIG. 9. As illustrated in FIG. 5, each of the spring holding portions 36 is arranged in the retainer housing portion 23 of the first outer ring body 11. A through hole 37 penetrating in the radial direction is formed in the spring holding portion 36. Then, the first coil spring 41 is arranged in the through hole 37.

The body portion 31 extends along the inner peripheral surface of the first outer ring body 11. The body portion 31 closes the radially inner side of the claw member housing portion 22. An opening portion 38 is formed between the body portion 31 and the spring holding portion 36. A distance between the body portion 31 and the spring holding portion 36 is H1.

As illustrated in FIG. 4, a closing wall 38a that closes the opening portion 38 is provided in the first direction X1 with respect to the opening portion 38. On the other hand, a notch 39 that opens the opening portion 38 and the claw member housing portion 22 in the second direction X2 is formed in the first retainer 30. Thus, as illustrated in FIG. 2, the opening portion 38 and the claw member housing portion 22 are opened in the second direction X2 by the notch 39, and the first claw member 40 can be arranged in the opening portion 38 and the claw member housing portion 22 by passing through the notch 39.

As illustrated in FIG. 5, the first claw member 40 includes a shaft portion 42 housed in the claw member housing portion 22, a claw portion 43 protruding from the shaft portion 42, and a protrusion portion 44 protruding from the shaft portion 42 in a direction opposite to the claw portion 43.

An outer diameter of the shaft portion 42 is circular when viewed along the axial direction. The outer diameter of the shaft portion 42 is larger than the width H1 of the opening portion 38 (see FIG. 5). Thus, the shaft portion 42 is rotatably sandwiched between the body portion 31 and the spring holding portion 36 without falling off from the opening portion 38.

The claw portion 43 passes through the opening portion 38 and is arranged on the radially inner side of the spring holding portion 36. The claw portion 43 is constantly biased inward in the radial direction by the first coil spring 41.

The protrusion portion 44 has a transmission surface 45 facing a direction opposite to a direction in which the claw portion 43 is arranged when viewed from the protrusion portion 44. The transmission surface 45 faces an inner surface 22a of the claw member housing portion 22.

As illustrated in FIG. 1, the hub 50 is formed in an annular shape around the central axis O. The output shaft 102 is inserted into the inner peripheral side of the hub 50. A female spline 50a is formed in the inner peripheral surface of the hub 50, and the hub 50 and the output shaft 102 are spline-fitted.

As illustrated in FIG. 1, a coupling wall 51 extending outward in the radial direction is formed on an outer peripheral surface of the hub 50. The coupling wall 51 extends in the circumferential direction along the outer peripheral surface of the hub 50 and is formed in an annular shape. The coupling wall 51 has a first surface 52 facing the first direction X1 and a second surface 53 facing the second direction X2.

The coupling wall 51 is arranged in the second direction X2 with respect to each of the first inner ring 1 and the first outer ring 10. The coupling wall 51 is fitted inside the fitting portion 17 of the first outer ring body 11. Thus, the hub 50 and the first outer ring body 11 are coupled.

A plurality of second triangular portions 54 and three second trapezoidal portions 55 protruding outward in the radial direction are formed on an outer peripheral portion of the coupling wall 51. A width in the circumferential direction of the second triangular portions 54 gradually decreases toward the outer side in the radial direction and is substantially triangular when viewed along the axial direction. Each of the second triangular portions 54 is fitted between the first triangular portions 18. Thus, the first outer ring body 11 and the hub 50 are coupled so as not to rotate relative to each other.

The second trapezoidal portions 55 have a larger width in the circumferential direction than the second triangular portions 54 and have a substantially trapezoidal shape when viewed along the axial direction. Second valley portions 56 having a large interval in the circumferential direction are formed between the second trapezoidal portions 55 and the second triangular portions 54 arranged in the second rotation direction L2 with respect to the second trapezoidal portions 55. The second trapezoidal portions 55 are fitted into the first valley portions 20 of the first outer ring body 11. The first trapezoidal portions 19 are fitted into the second valley portions 56.

When the coupling wall 51 is fitted into the fitting portion 17 of the first outer ring body 11, there is a possibility that the second surface 53 of the coupling wall 51 may erroneously face the first outer ring body 11 instead of the first surface 52. In this case, the second valley portions 56 are arranged not in the second rotation direction L2 with respect to the second trapezoidal portions 55 but in the first rotation direction L1. Thus, when the coupling wall 51 is to be fitted into the fitting portion 17, the first trapezoidal portions 19 and the second trapezoidal portions 55 overlap with each other in the axial direction, and the coupling wall 51 is not fitted into the fitting portion 17. From the above, erroneous assembling of the hub 50 and the first outer ring body 11 (hereinafter, simply referred to as erroneous assembly) is prevented.

As illustrated in FIG. 3, six hub fixing holes 57 and three hub spring holes 58 penetrating in the axial direction are formed in the coupling wall 51.

FIG. 6 is a sectional view of the hub fixing hole of the first embodiment taken along the axial direction, and is specifically a sectional view taken along a line VI-VI in FIG. 2. As illustrated in FIG. 6, the hub fixing hole 57 is arranged in the axial direction with respect to the retainer fixing hole 34 and the outer-ring fixing hole 12. Then, a shaft portion 59a of a rivet 59 is inserted into the hub fixing hole 57, the retainer fixing hole 34, and the outer-ring fixing hole 12. A head portion 59b of the rivet 59 abuts on the coupling wall 51 from the second direction X2.

In addition, a caulking portion 59c is formed at an end portion in the first direction X1 of the shaft portion 59a of the rivet 59. The forming thereof is performed by caulking of the end portion in the first direction X1 of the shaft portion 59a of the rivet 59. The caulking portion 59c abuts on the first outer ring body 11 from the first direction X1. Thus, the first outer ring body 11, the first retainer 30, and the hub 50 are integrated. The coupling wall 51 closes the notch 39 of the first retainer 30 (see FIG. 4) from the second direction X2. Thus, the first claw member 40 does not fall off from the claw member housing portion 22.

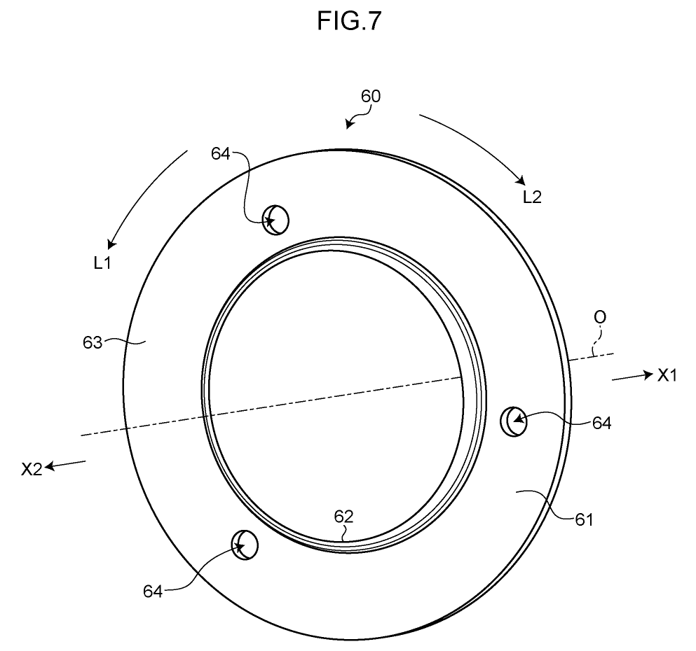

FIG. 7 is a perspective view of the first selectable plate of the first embodiment as viewed from the second direction. The first selectable plate 60 is formed in an annular shape around the central axis O. The first selectable plate 60 includes a plate body 61 arranged in the first direction X1 with respect to the first outer ring 10 and a cam portion 62 extending in the second direction X2 from an end portion on the radially inner side of the plate body 61. Three selectable-plate spring holes 64 are formed in the plate body 61.

FIG. 8 is a sectional view of the selectable-plate spring hole of the first embodiment taken along the axial direction, and is specifically a sectional view taken along a line VIII-VIII in FIG. 2. As illustrated in FIG. 8, the selectable-plate spring hole 64 overlaps with the outer-ring spring hole 13, the retainer spring hole 35, and the hub spring hole 58 as viewed along the axial direction.

The first selectable plate 60 is coupled to the first outer ring 10 by a first coupling mechanism 70. The first coupling mechanism 70 includes a first pin 71, a retaining ring (second retaining portion) 72, and a first coil spring 73 for a selectable plate (first biasing member for a selectable plate). In the first pin 71, a rod-shaped shaft portion 74 and a head portion (first retaining portion) 75 provided at one end of the shaft portion 74 are integrally formed.

The shaft portion 74 of the first pin 71 is inserted into the hub spring hole 58 from the second direction X2. Then, the shaft portion 74 extends in the axial direction across the retainer spring hole 35, the outer-ring spring hole 13, and the selectable-plate spring hole 64. An end portion in the first direction X1 of the shaft portion 74 protrudes in the first direction X1 compared to the first selectable plate 60. Then, the retaining ring 72 is attached to the end portion in the first direction X1 of the shaft portion 74.

An annular pedestal 79 protruding inward in the radial direction is formed at an end portion in the first direction X1 of an inner peripheral surface of the outer-ring spring hole 13. The first coil spring 73 for the selectable plate penetrates the shaft portion 74 of the first pin 71 and is housed in the outer-ring spring hole 13. One end of the first coil spring 73 for the selectable plate abuts on a head portion 75 of the first pin 71. The other end of the first coil spring 73 for the selectable plate abuts on the pedestal 79.

The first coil spring 73 for the selectable plate is assembled in a compressed state. Thus, the first coil spring 73 for the selectable plate constantly biases the head portion 75 of the first pin 71 in the second direction X2. That is, the first selectable plate 60 is constantly pressed in the second direction X2 by the retaining ring 72. Thus, when a load in the first direction X1 does not act on the plate body 61, the plate body 61 is in a state of abutting on the first side surface 14 of the first outer ring 10.

An outer diameter of the plate body 61 is larger than an outer diameter of the first outer ring body 11. Thus, the end portion on the radially outer side of the plate body 61 is a first power transmission portion 63 protruding outward in the radial direction compared to the outer peripheral surface 11a of the first outer ring body 11. Furthermore, the entire portion in the circumferential direction of the end portion of the plate body 61 on the radially outer side protrudes outward in the radial direction compared to the first outer ring 10. Thus, the first power transmission portion 63 is formed in an annular shape.

FIG. 9 is a sectional view of the selectable one-way clutch of the first embodiment in a torque interruption state, and is specifically a sectional view taken along a line IX-IX in FIG. 2. As illustrated in FIG. 9, the cam portion 62 is arranged between the first inner ring 1 and the first outer ring 10. In a state in which the plate body 61 is in a state of abutting on the first side surface 14 of the first outer ring 10, the cam portion 62 abuts on the claw portion 43 from the inner side in the radial direction, and lifts the claw portion 43 outward in the radial direction. The cam portion 62 is located on the inner side in the radial direction and is inclined toward the second direction X2. Thus, a tip portion of the cam portion 62 easily enters the radially inner side of the claw portion 43.

The shift drum 80 is an annular component; and the first outer ring 10, the first inner ring 1, and the hub 50 are arranged inside the shift drum. A length in the axial direction of the shift drum 80 is substantially the same as a length in the axial direction of the first outer ring 10. A side surface in the first direction X1 of the shift drum 80 is a first pressing surface 81 facing the first power transmission portion 63.

In an outer peripheral surface 84 of the shift drum 80, an annular recessed portion (coupling portion) 85 recessed inward in the radial direction is formed. A shift fork 110 coupled to a linear motion mechanism is inserted into the recessed portion 85. When the linear motion mechanism is driven, the shift fork 110 moves in the axial direction, and the shift drum 80 correspondingly moves in the axial direction.

An inner peripheral surface 82 of the shift drum 80 abuts on the outer peripheral surface 11a of the first outer ring 10 so as to be slidable in the axial direction. As illustrated in FIG. 2, a groove 83 recessed in the radial direction and extending in the axial direction is formed in the inner peripheral surface 82 of the shift drum 80. The protrusion portion 21 of the first outer ring body 11 is arranged in the groove 83. Thus, the shift drum 80 is movable in the axial direction with respect to the first outer ring 10 and is not relatively rotatable.

As illustrated in FIG. 9, a first locking groove 86 and a second locking groove 87 recessed outward in the radial direction and extending in the circumferential direction are formed in the inner peripheral surface 82 of the shift drum 80. The first locking groove 86 is formed at a central portion in the axial direction of the shift drum 80. The second locking groove 87 is arranged in the second direction X2 with respect to the first locking groove 86. Each of the first locking groove 86 and the second locking groove 87 is formed in an annular shape.

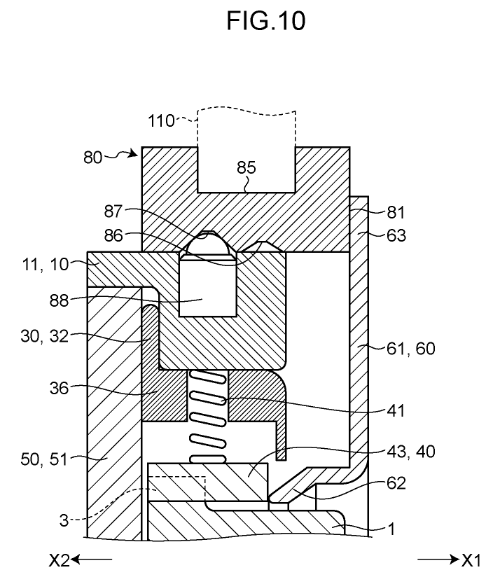

A plunger 88 is provided radially inside the shift drum 80. Although not specifically illustrated, three plungers 88 are provided at intervals of 120°. The plunger 88 is arranged in a hole 10b formed in the outer peripheral surface of the first outer ring 10. The plunger 88 is located at the central portion in the width direction of the first outer ring 10. Then, a ball of the plunger 88 enters the first locking groove 86. In a case where the shift drum 80 moves in the first direction X1, the ball of the plunger 88 enters the second locking groove 87 (see FIG. 10).

In a state in which the ball of the plunger 88 enters the first locking groove 86, the first pressing surface 81 of the shift drum 80 does not press the first power transmission portion 63. Thus, no load in the first direction X1 is generated in the first selectable plate 60.

Next, an operation of the selectable one-way clutch 100 of the first embodiment will be described. First, an initial state of the selectable one-way clutch 100 will be described. The initial state of the selectable one-way clutch 100 is a state in which transmission of torque is interrupted. A direction in which the input shaft 101 rotates is the first rotation direction L1. Thus, the first inner ring 1 also rotates in the first rotation direction L1.

As illustrated in FIG. 9, in the initial state of the selectable one-way clutch 100, the ball of the plunger 88 enters the first locking groove 86. Thus, the first pressing surface 81 of the shift drum 80 simply abuts on the first selectable plate 60. In addition, the cam portion 62 of the first selectable plate 60 lifts the first claw member 40 (see also FIG. 5). That is, the claw portion 43 of the first claw member 40 is not engaged with the first tooth portion 3. Thus, the torque is not transmitted to the first outer ring 10, and the hub 50 and the output shaft 102 also do not rotate.

Since the ball of the plunger 88 enters the first locking groove 86 at the time of the torque interruption, even in a case where the linear motion mechanism is not activated, a positional deviation of the shift drum 80 is prevented.

FIG. 10 is a sectional view of a torque transmission state of the selectable one-way clutch of the first embodiment. On the other hand, when the linear motion mechanism is driven and the shift fork 110 moves in the first direction X1, the shift drum 80 moves in the first direction X1. The first pressing surface 81 of the shift drum 80 presses the first power transmission portion 63 in the first direction X1 against biasing force of the first coil spring 73 for the selectable plate. As a result, the first selectable plate 60 moves in the first direction X1, and the lifting of the claw portion 43 by the cam portion 62 is released.

The claw portion 43 is constantly biased inward in the radial direction by the first coil spring 41. Thus, the claw portion 43 enters a space between the first tooth portions 3 (see a virtual line K40 in FIG. 5). As a result, the claw portion 43 is pressed against the first tooth portion 3. The transmission surface 45 of the protrusion portion 44 of the first claw member 40 presses the inner surface 22a of the claw member housing portion 22 in the first rotation direction L1. As a result, the torque is transmitted to the first outer ring 10, and the first outer ring 10 and the hub 50 rotate in the first rotation direction L1. As a result, the output shaft 102 coupled to the hub 50 also rotates in the first rotation direction L1. When the shift drum 80 moves in the first direction X1 in such a manner, the selectable one-way clutch 100 transmits the torque.

When the shift drum 80 moves in the first direction X1, the biasing force of the first coil spring 73 for the selectable plate acts on the shift drum 80. Thus, the linear motion mechanism needs to continuously generate power in such a manner that the shift drum 80 does not move in the second direction X2, which leads to a large load. On the other hand, in the present embodiment, when the shift drum 80 moves in the first direction X1, the ball of the plunger 88 enters the second locking groove 87, and the shift drum 80 hardly moves in the second direction X2. Thus, the load on the linear motion mechanism is reduced.

At the time of the torque transmission, the shift drum 80 rotates in the first rotation direction L1 since the shift drum 80 is not rotatable relative to the first outer ring 10. On the other hand, since the shift fork 110 does not rotate, the recessed portion 85 of the shift drum 80 slides with respect to the shift fork 110.

Then, when the linear motion mechanism is driven and the shift fork 110 moves in the second direction X2, the shift drum 80 moves in the second direction X2. The ball of the plunger 88 enters the first locking groove 86, and the shift drum 80 returns to the initial position. Thus, the pressing of the first selectable plate 60 by the shift drum 80 is released. Then, the first selectable plate 60 moves in the second direction X2 by the biasing force of the first coil spring 73 for the selectable plate.

Here, the first claw member 40 is sandwiched between the first tooth portion 3 and the inner surface 22a (see the virtual line K40 in FIG. 5). That is, in the first claw member 40, clamping force acts between the first tooth portion 3 and the inner surface 22a. Thus, although the tip portion of the cam portion 62 enters the radially inner side of the claw portion 43 by the biasing force of the first coil spring 73 for the selectable plate, the claw portion 43 cannot be lifted up when the torque transmitted from the first inner ring 1 to the first outer ring 10 is large. Thus, the torque is continuously transmitted from the first inner ring 1 to the first outer ring 10.

On the other hand, when the torque transmitted from the first inner ring 1 to the first outer ring 10 is small, the clamping force acting on the first claw member 40 also becomes small. Thus, the first selectable plate 60 moves in the second direction X2, and the cam portion 62 lifts the claw portion 43. As a result, the first claw member 40 is disengaged from the first tooth portion 3, and torque transmission is interrupted. In addition, the first selectable plate 60 abuts on the first side surface 14 of the first outer ring 10.

In a case where the direction in which the input shaft 101 rotates is the second rotation direction L2, the claw portion 43 rides on the first tooth portion 3, and the first claw member 40 and the first tooth portion 3 do not engage with each other. Thus, in a case where the input shaft 101 rotates in the second direction X2, the torque is not transmitted to the first outer ring 10.

As described above, according to the first embodiment, the first power transmission portion 63 of the first selectable plate 60 protrudes outward in the radial direction with respect to the plate body 61. In addition, the shift drum 80 that presses the first power transmission portion 63 is arranged outside the first outer ring 10 in the radial direction. Thus, the first power transmission portion 63 and the shift drum 80 do not protrude in the first direction X1 from the plate body 61 of the first selectable plate 60, and the selectable one-way clutch 100 is reduced in size in the axial direction.

Furthermore, when the first outer ring 10 rotates, the shift drum 80 rotates together with the first outer ring 10. Thus, wearing of the outer peripheral surface 11a of the first outer ring 10 and the inner peripheral surface 82 of the shift drum 80 is prevented.

When switching from the torque transmission state (see FIG. 10) to the torque interruption state (see FIG. 9) is made, the first selectable plate 60 moves in the second direction X2 by the biasing force of the first coil spring 73 for the selectable plate, and the cam portion 62 lifts the claw portion 43. When the first selectable plate 60 is forcibly moved in the second direction X2 by the power generated by the linear motion mechanism, the cam portion 62 lifts the claw portion 43 even when the clamping force acting on the first claw member 40 is large. As a result, the load acting on the cam portion 62 and the claw portion 43 increases, which may cause deformation. In the present embodiment, in a case where the clamping force acting on the first claw member 40 is small, since the cam portion 62 lifts the claw portion 43, the load acting on the cam portion 62 and the claw portion 43 is small and deformation is less likely to occur.

Furthermore, an outer diameter of the coupling wall 51 is different between a shape viewed from the first direction X1 and a shape viewed from the second direction X2 due to the second trapezoidal portion 55 and the second valley portion 56. Thus, it is possible to prevent erroneous assembling of the coupling wall 51 (hub 50) and the first outer ring body 11 (first outer ring 10).

Next, a selectable one-way clutch 100A of a second embodiment will be described. In the following description, only differences from the first embodiment will be described.

### Second Embodiment

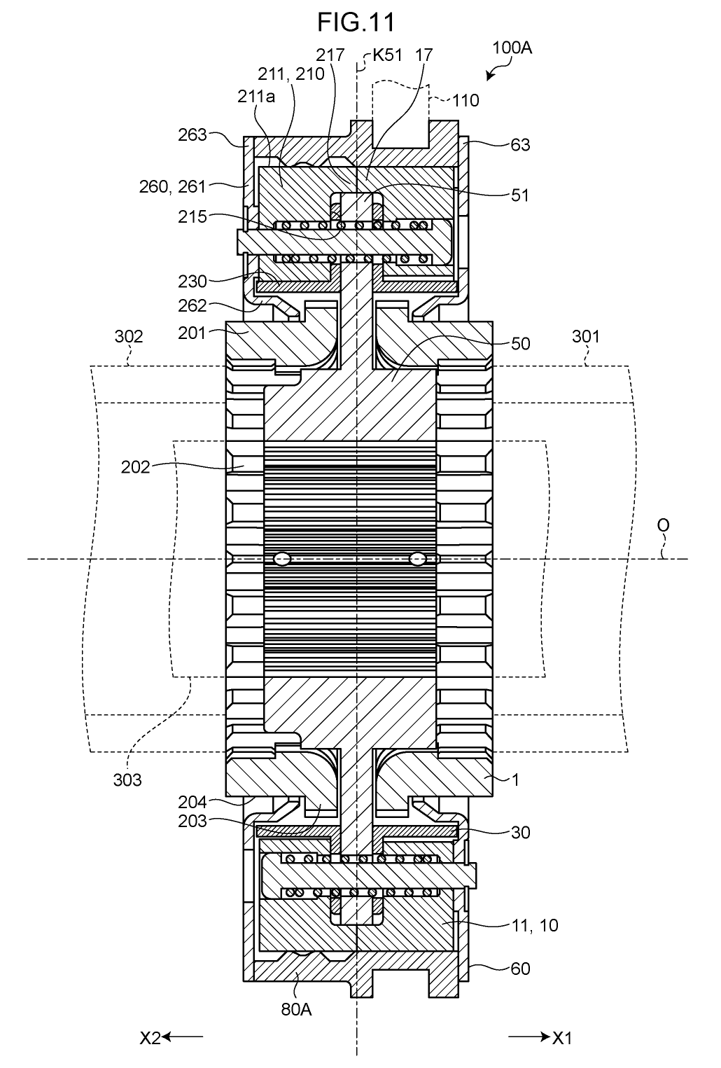

FIG. 11 is a sectional view of a selectable one-way clutch of the second embodiment taken along a central axis. As illustrated in FIG. 11, the selectable one-way clutch 100A of the second embodiment is interposed between two input shafts (first input shaft 301 and second input shaft 302) and one output shaft 303.

The selectable one-way clutch 100A of the second embodiment is different from that of the first embodiment in a point that a second inner ring 201, a second outer ring 210, and a second selectable plate 260 are further included. Hereinafter, the second inner ring 201, the second outer ring 210, and the second selectable plate 260 will be described. As illustrated in FIG. 11, a virtual plane overlapping with a coupling wall 51 is referred to as a virtual plane K51.

The second inner ring 201 is formed plane-symmetrically with the first inner ring 1 with respect to the virtual plane K51. A plurality of female splines 202 are formed in an inner peripheral surface of the second inner ring 201. The second input shaft 302 is spline-fitted to an inner peripheral side of the second inner ring 201. A plurality of second tooth portions 203 are formed on an outer peripheral surface 204 of the second inner ring 201. A rotational speed of the second input shaft 302 is different from a rotational speed of the first input shaft 301 connected to the first inner ring 1.

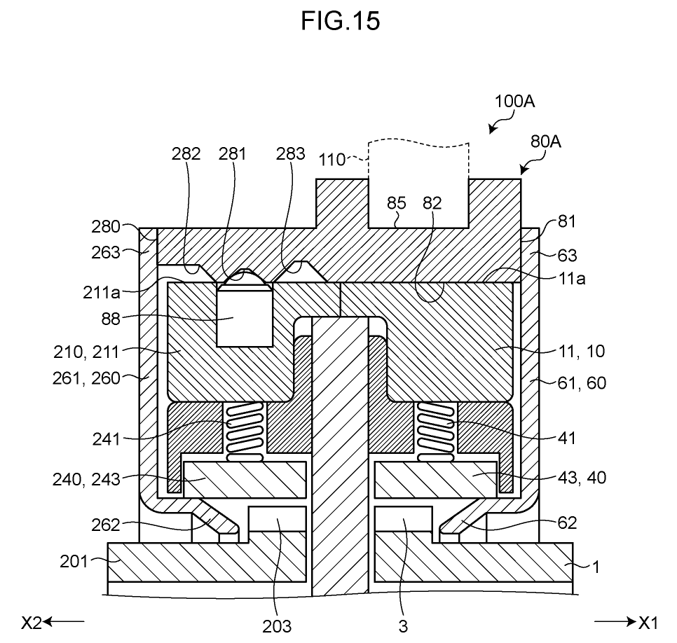

The second outer ring 210 includes a second outer ring body 211, a second retainer 230, a second claw member 240 (see FIG. 15), and a second coil spring 241 (see FIG. 15). The components of the second outer ring 210 are respectively formed plane-symmetrically with components of the first outer ring 10 with respect to the virtual plane K51.

Thus, on a side surface 215 in the first direction X1 of the second outer ring body 211, a fitting portion 217 into which a coupling wall 51 of a hub 50 is fitted is formed on the inner peripheral side, similarly to the first outer ring body 11. Similarly to the fitting portion 17 of the first outer ring body 11, a plurality of third crest portions (not illustrated), three third trapezoidal portions (not illustrated), and three third valley portions (not illustrated) are formed on the inner peripheral side of the fitting portion 217.

The second triangular portions 54 (see FIG. 3) of the coupling wall 51 are fitted between the third crest portions (not illustrated). The third trapezoidal portions (not illustrated) are fitted into the second valley portions 56 (see FIG. 3). The second trapezoidal portions 55 (see FIG. 3) are fitted into the third valley portions (not illustrated). From the above, the second outer ring body 211 is coupled to the hub 50 in a manner of being relatively non-rotatable. In a case where the second outer ring body 211 is erroneously fitted from the first direction X1 of the hub 50, the second trapezoidal portions 55 of the hub 50 and the third trapezoidal portions overlap in an axial direction and are not fitted. Thus, similarly to the first outer ring body 11, erroneous assembly to the hub 50 is prevented.

The second selectable plate 260 is formed plane-symmetrically with the first selectable plate 60 with respect to the virtual plane K51. Thus, the second selectable plate 260 includes a plate body 261 arranged in the second direction X2 of the second outer ring 210, a cam portion 262 that lifts a claw portion 243 of the second claw member 240 (see FIG. 15), and a second power transmission portion 263 that protrudes outward in the radial direction compared to an outer peripheral surface 211a of the second outer ring body 211.

As described above, the second inner ring 201, the second outer ring 210, and the second selectable plate 260 are plane-symmetrical with respect to the virtual plane K51. However, structures to fix the first outer ring 10 and the second outer ring 210 to the hub 50 are not plane-symmetrical. In addition, structures to fix the first selectable plate 60 and the second selectable plate 260 are not plane-symmetrical. Hereinafter, the structures that are not plane-symmetrical will be described.

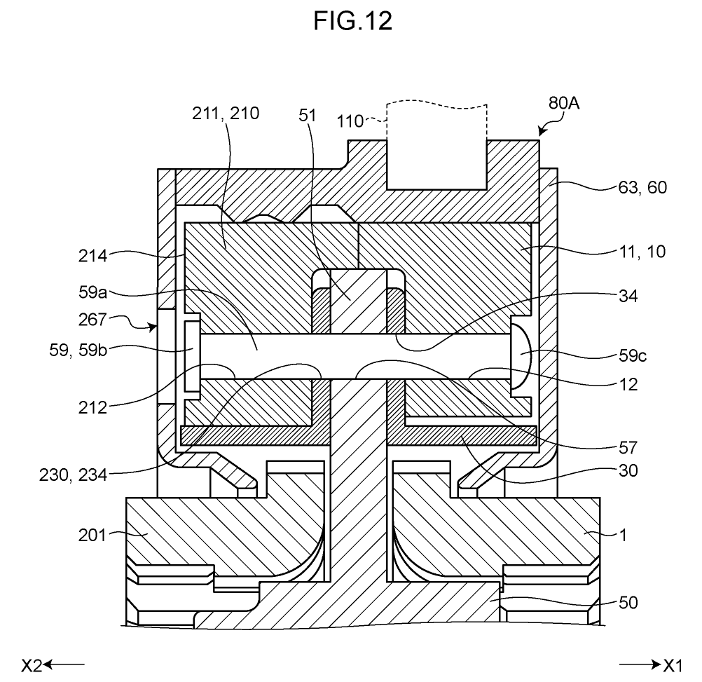

FIG. 12 is a sectional view of the selectable one-way clutch of the second embodiment taken along a rivet in the axial direction. As illustrated in FIG. 12, an outer-ring fixing hole 212 penetrating in the axial direction is formed in the second outer ring body 211. A retainer fixing hole 234 penetrating in the axial direction is formed in the second retainer 230. An insertion hole 267 penetrating in the axial direction is formed in the second selectable plate 260. The outer-ring fixing hole 212, the retainer fixing hole 234, and the insertion hole 267 are arranged in the axial direction with respect to the hub fixing hole 57, the retainer fixing hole 34, and the outer-ring fixing hole 12.

The rivet 59 is inserted in the second direction X2 of the insertion hole 267, and the shaft portion 59a of the rivet 59 extends in the axial direction across the outer-ring fixing hole 212, the retainer fixing hole 234, the hub fixing hole 57, the retainer fixing hole 34, and the outer-ring fixing hole 12. The head portion 59b of the rivet 59 abuts on a side surface 214 in the second direction X2 of the second outer ring body 211 from the second direction X2.

The caulking portion 59c formed at an end portion in the first direction X1 of the shaft portion 59a abuts on the first outer ring body 11 from the first direction X1. Thus, the first outer ring body 11, the first retainer 30, the hub 50, the second outer ring body 211, and the second retainer 230 are integrated. That is, the first outer ring 10, the second outer ring 210, and the hub 50 rotate together.

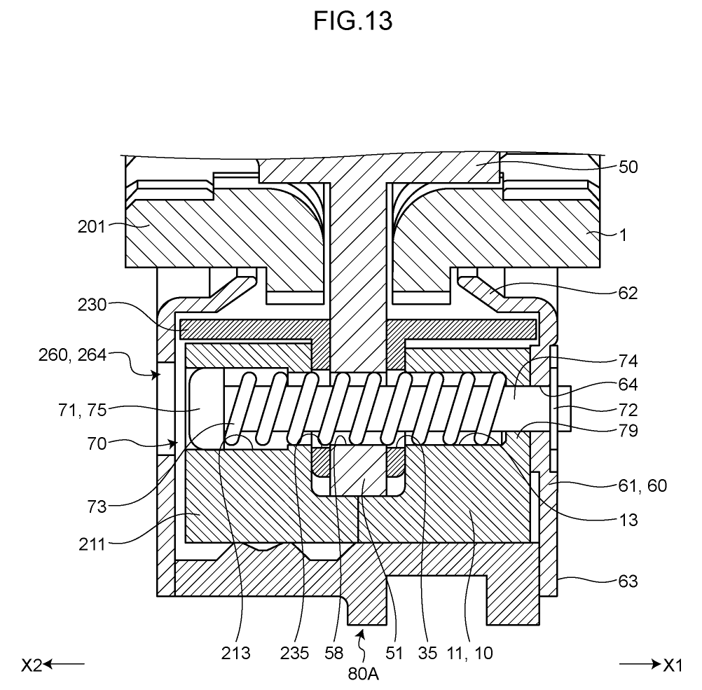

FIG. 13 is a sectional view of the selectable one-way clutch of the second embodiment taken along a first pin in the axial direction. As illustrated in FIG. 13, an outer-ring spring hole 213 penetrating in the axial direction is formed in the second outer ring body 211. A retainer spring hole 235 penetrating in the axial direction is formed in the second retainer 230. A selectable-plate spring hole 264 penetrating in the axial direction is formed in the second selectable plate 260. The selectable-plate spring hole 264, the outer-ring spring hole 213, and the retainer spring hole 235 overlap with a hub spring hole 58, a retainer spring hole 35, an outer-ring spring hole 13, and a selectable-plate spring hole 64 in the axial direction.

The first pin 71 is inserted into the selectable-plate spring hole 264 from the second direction X2. Then, the shaft portion 74 of the first pin 71 extends in the axial direction across the outer-ring spring hole 213, the retainer spring hole 235, the hub spring hole 58, the retainer spring hole 35, the outer-ring spring hole 13, and the selectable-plate spring hole 64. The retaining ring 72 is provided at an end portion in the first direction X1 of the shaft portion 74. The retaining ring 72 abuts on the first selectable plate 60 from the first direction X1.

One end of the first coil spring 73 for a selectable plate abuts on the head portion 75 of the first pin 71. The other end of the first coil spring 73 for the selectable plate abuts on the pedestal 79. The first coil spring 73 for the selectable plate is assembled in a compressed state. Thus, the first selectable plate 60 is constantly pressed in the second direction X2 by the retaining ring 72, and the plate body 61 abuts on the first outer ring 10.

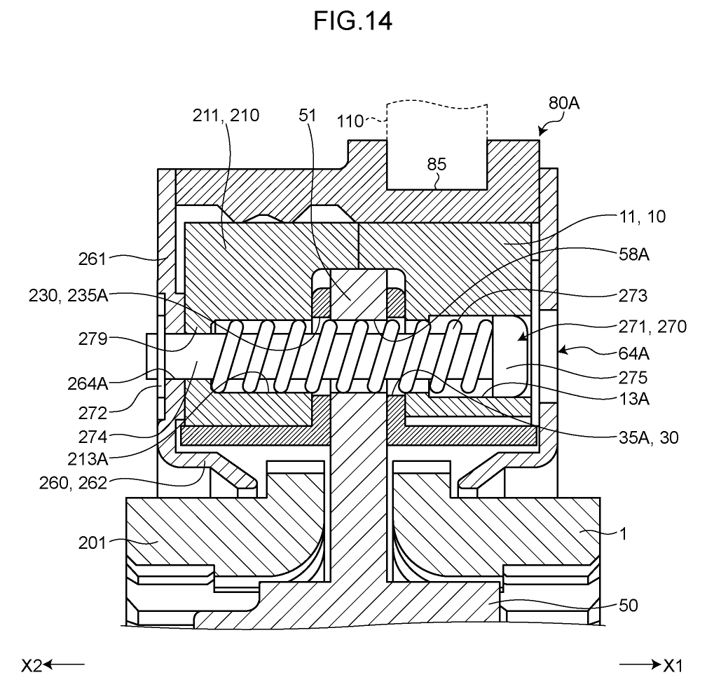

FIG. 14 is a sectional view of the selectable one-way clutch of the second embodiment taken along a fourth pin in the axial direction. As illustrated in FIG. 14, the second selectable plate 260 is fixed by a second coupling mechanism 270. The second coupling mechanism 270 includes a second pin 271, a retaining ring 272, and a second coil spring 273 for a selectable plate.

An outer-ring spring hole 13A is formed in the first outer ring body 11. A retainer spring hole 35A is formed in the first retainer 30. A selectable-plate spring hole 64A is formed in the first selectable plate 60. A hub spring hole 58A is formed in the coupling wall 51 of the hub 50. An outer-ring spring hole 213A is formed in the second outer ring body 211. A retainer spring hole 235A is formed in the second retainer 230. A selectable-plate spring hole 264A is formed in the second selectable plate 260. The outer-ring spring hole 13A, the retainer spring hole 35A, the selectable-plate spring hole 64A, the hub spring hole 58A, the outer-ring spring hole 213A, and the retainer spring hole 235A are arranged so as to overlap with each other in the axial direction.

The second pin 271 is inserted into the selectable-plate spring hole 64A from the first direction X1. Then, a shaft portion 274 of the second pin 271 extends in the axial direction across the outer-ring spring hole 13A, the retainer spring hole 35A, the hub spring hole 58A, the retainer spring hole 235A, the outer-ring spring hole 213A, and the selectable-plate spring hole 264A. The retaining ring 272 is provided at an end portion in the second direction X2 of the shaft portion 274. The retaining ring 272 abuts on the second selectable plate 260 from the second direction X2.

One end of the second coil spring 273 for the selectable plate abuts on a head portion 275 of the second pin 271. The other end of the second coil spring 273 for the selectable plate abuts on a pedestal 279 formed in the outer-ring spring hole 213A. The second coil spring 273 for the selectable plate is assembled in a compressed state. Thus, the second selectable plate 260 is constantly pressed in the first direction X1 by the retaining ring 272, and the plate body 261 abuts on the second outer ring 210.

FIG. 15 is a sectional view of the selectable one-way clutch of the second embodiment taken along the axial direction in such a manner that claw portions of a first claw member and a second claw member overlap. As illustrated in FIG. 15, a shift drum 80A of the second embodiment is longer in the axial direction than the shift drum 80 of the first embodiment and is substantially equal to a total length in the axial direction of the first outer ring 10 and the second outer ring 210. The shift drum 80A has a second pressing surface 280 facing the second direction X2 and facing the second power transmission portion 263.

The plunger 88 of the second embodiment is provided in the second outer ring body 211. A first locking groove 281, a second locking groove 282, and a third locking groove 283 are formed in the inner peripheral surface 82 of the shift drum 80A. In a state in which a linear motion mechanism is not activated, the plunger 88 is fitted into the first locking groove 281. The second locking groove 282 is arranged in the second direction X2 of the first locking groove 281. The third locking groove 283 is arranged in the first direction X1 of the first locking groove 281. The second locking groove 282 is open toward the second direction X2.

Next, the selectable one-way clutch 100A of the second embodiment will be described.

As illustrated in FIG. 15, in an initial state of the selectable one-way clutch 100A, a ball of the plunger 88 enters the first locking groove 281. Thus, the first pressing surface 81 of the shift drum 80A simply abuts on the first power transmission portion 63 of the first selectable plate 60. In addition, the cam portion 62 of the first selectable plate 60 lifts the claw portion 43 of the first claw member 40. Thus, torque is not transmitted from the first inner ring 1 to the first outer ring 10.

In the initial state of the selectable one-way clutch 100A, the second pressing surface 280 of the shift drum 80A is in a state of simply abutting on the second power transmission portion 263 of the second selectable plate 260. The cam portion 262 of the second selectable plate 260 lifts the claw portion 243 of the second claw member 240. Thus, torque is not transmitted from the second inner ring 201 to the second outer ring 210. From the above, the torque of the first input shaft 301 and the second input shaft 302 is not transmitted to the output shaft 303 (see FIG. 11).

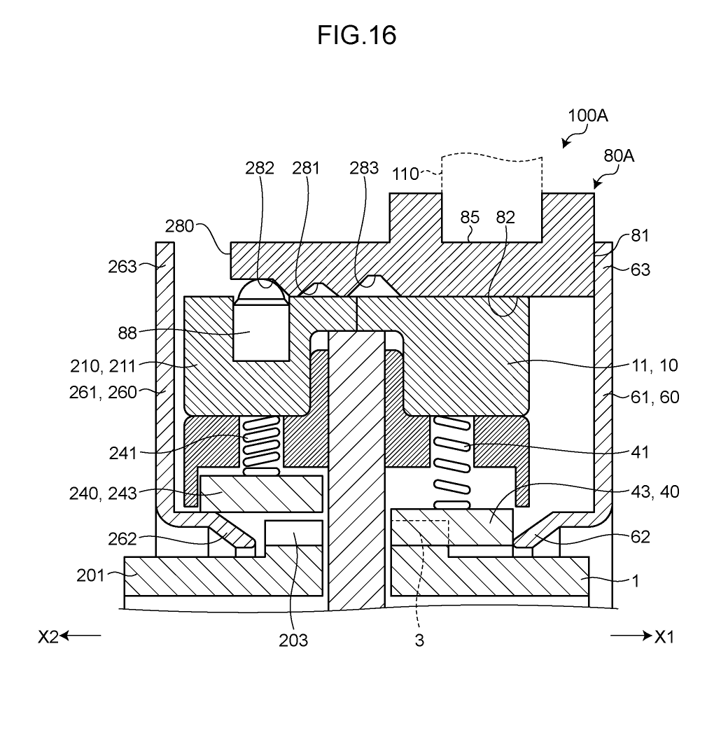

FIG. 16 is a sectional view of the selectable one-way clutch of the second embodiment in a state in which torque is transmitted between the first inner ring and the first outer ring. As illustrated in FIG. 16, when the linear motion mechanism is driven and a shift fork 110 moves in the first direction X1, the first pressing surface 81 of the shift drum 80A presses the first power transmission portion 63 in the first direction X1 against biasing force of the first coil spring 73 for the selectable plate. As a result, the first selectable plate 60 moves in the first direction X1, and the lifting of the claw portion 43 by the cam portion 62 is released.

The claw portion 43 biased inward in the radial direction by the first coil spring 41 enters a space between first tooth portions 3. As a result, the first claw member 40 is pressed in the first rotation direction L1, and the torque is transmitted to the first outer ring 10. Then, the first outer ring 10, the second outer ring 210, and the hub 50 rotate in the first rotation direction L1, and the output shaft 303 coupled to the hub 50 also rotates in the first rotation direction L1. When the first outer ring 10, the second outer ring 210, and the hub 50 rotate, the shift drum 80A also rotates in the first rotation direction L1.

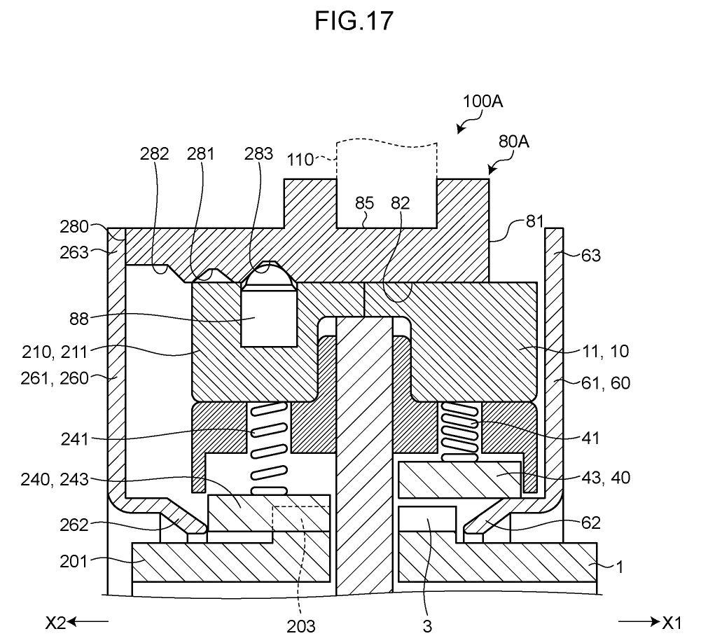

FIG. 17 is a sectional view of the selectable one-way clutch of the second embodiment in a state in which torque is transmitted between the second inner ring 201 and the second outer ring 210. As illustrated in FIG. 17, when the linear motion mechanism is driven and the shift fork 110 moves in the second direction X2, the second pressing surface 280 of the shift drum 80A presses the second power transmission portion 263 in the second direction X2 against the biasing force of the second coil spring 273 for the selectable plate. As a result, the second selectable plate 260 moves in the second direction X2, and the lifting of the claw portion 243 by the cam portion 262 is released.

The claw portion 243 biased inward in the radial direction by the second coil spring 241 enters a space between the second tooth portions 203. As a result, the second claw member 240 is pressed in the first rotation direction L1, and the torque is transmitted to the second outer ring 210. That is, the first outer ring 10, the second outer ring 210, and the hub 50 rotate in the first rotation direction L1, and the output shaft 303 coupled to the hub 50 also rotates in the first rotation direction L1. When the first outer ring 10, the second outer ring 210, and the hub 50 rotate, the shift drum 80A also rotates in the first rotation direction L1.

As described above, according to the second embodiment, the torque to be transmitted to the output shaft 303 can be selected as the torque of the first input shaft 301 or the torque of the second input shaft 302. In addition, the two selectable plates (first selectable plate 60 and second selectable plate 260) are movable by the one shift drum 80A. Thus, the number of shift drums 80A is small, and the number of components can be reduced.

In addition, when the pressing force by the shift drum 80A is released, the second selectable plate 260 moves in the first direction X1 by the biasing force of the second coil spring 273 for the selectable plate. When clamping force acting on the second claw member 240 decreases, the cam portion 262 lifts the claw portion 243. That is, a load acting on the cam portion 62 and the claw portion 243 is small. Thus, deformation of the cam portion 262 and the second claw member 240 is prevented.

Although the embodiments have been described above, the present disclosure is not limited to the examples described in the embodiments. For example, although the claw members (first claw member 40 and second claw member 240) are provided on a side of the outer rings (first outer ring 10 and second outer ring 210) and the tooth portions (first tooth portion 3 and second tooth portion 203) are provided on a side of the inner rings (first inner ring 1 and second inner ring 201), claw members may be provided on an inner ring side and tooth portions may be provided on an outer ring side in the present disclosure.

In the present embodiment, in order to prevent erroneous assembly of the first outer ring 10 and the hub 50, the first trapezoidal portions 19 and the first valley portions 20 are provided in the fitting portion 17, and the second trapezoidal portions 55 and the second valley portions 56 are provided in the coupling wall 51. When the outer diameter of the coupling wall 51 is different between the shape viewed from the first direction X1 and the shape viewed from the second direction X2, it is possible to prevent erroneous assembly of the first outer ring 10 and the hub 50. Thus, the present disclosure may prevent erroneous assembly by a shape other than the shapes described in the embodiments.

Although the first selectable plate 60 is moved in the second direction X2 by the first coil spring 73 for the selectable plate of the first coupling mechanism 70 in the first embodiment, the present disclosure is not limited thereto. For example, the first power transmission portion 63 of the first selectable plate 60 may be coupled to the shift drum 80, and the first selectable plate 60 may move in the second direction X2 together with the shift drum 80. That is, the first coupling mechanism 70 is not an essential component in the present disclosure.

Although the first selectable plate 60 and the second selectable plate 260 are restored to the initial state by the first coil spring 73 for the selectable plate and the second coil spring 273 for the selectable plate in the second embodiment, as described above, the present disclosure may not include both the first coil spring 73 for the selectable plate and the second coil spring 273 for the selectable plate.

Although the shift drums 80 and 80A are not rotatable relative to the first outer ring 10 or the like, the relative rotation may be possible in the present disclosure.

The present disclosure may be a combination of the following configurations.

A selectable one-way clutch comprising:

a first inner ring formed in an annular shape;

a first outer ring formed in an annular shape and having the first inner ring arranged inside the first outer ring;

a shift drum formed in an annular shape and having the first inner ring and the first outer ring arranged inside the shift drum; and

a first selectable plate that separates the first inner ring and the first outer ring from each other, wherein

a direction parallel to a rotation axis of the first inner ring is an axial direction,

one side of the axial direction is a first direction,

another side of the axial direction is a second direction,

a plurality of first tooth portions are formed on one of an outer peripheral surface of the first inner ring and an inner peripheral surface of the first outer ring,

a first claw member that is tiltable and a first biasing member that biases the first claw member toward the first tooth portions are provided on the other of the outer peripheral surface of the first inner ring and the inner peripheral surface of the first outer ring,

the first selectable plate includes

an annular plate body arranged in the first direction with respect to the first outer ring, and

a first cam portion that extends in the second direction from an end portion on a radially inner side of the plate body and lifts the first claw member against biasing force of the first biasing member,

an end portion on a radially outer side of the plate body is a first power transmission portion that protrudes radially outward compared to an outer peripheral surface of the first outer ring,

a coupling portion coupled to a linear motion mechanism is formed on an outer peripheral surface of the shift drum,

a side surface of the shift drum facing the first direction is a first pressing surface facing the first power transmission portion in the axial direction, and

when the shift drum is moved in the first direction, the first power transmission portion is pressed in the first direction and lifting of the first claw member by the first cam portion is released.(2) The selectable one-way clutch according to (1), wherein

a groove recessed radially outward and extending in the axial direction is formed in an inner peripheral surface of the shift drum,

a protrusion portion protruding radially outward and extending in the axial direction is formed on an outer peripheral surface of the first outer ring, and

the protrusion portion is arranged in the groove, and the shift drum is movable in the axial direction and is not relatively rotatable with respect to the first outer ring.

(3) The selectable one-way clutch according to (1), further comprising

a first coupling mechanism that couples the first outer ring and the first selectable plate, wherein

the first coupling mechanism includes

a shaft portion that penetrates the first outer ring and the first selectable plate in the axial direction,

a first retaining portion provided at an end portion in the first direction of the shaft portion,

a second retaining portion provided at an end portion in the second direction of the shaft portion, and

a first biasing member for a selectable plate,

the first biasing member for a selectable plate is arranged between the first outer ring and the second retaining portion and constantly biases the second retaining portion in the second direction, and

when pressing by the shift drum is released, the first selectable plate is pressed in the second direction by the first retaining portion.

(4) The selectable one-way clutch according to (1), further comprising

an annular hub arranged inside the first inner ring, wherein

an annular coupling wall extending radially outward is formed on an outer peripheral surface of the hub,

the coupling wall is arranged in the second direction with respect to the first inner ring and the first outer ring, and

the first outer ring and the coupling wall are coupled in a manner of not being relatively rotatable.

(5) The selectable one-way clutch according to (4), wherein

an annular fitting wall protruding in the second direction and surrounding an outer peripheral side of the coupling wall is formed on a side surface of the first outer ring facing the second direction,

the coupling wall is fitted into an inner peripheral side of the fitting wall, and

an outer diameter of the coupling wall is different between a shape viewed from the first direction and a shape viewed from the second direction.

(6) The selectable one-way clutch according to (4) or (5), further comprising

an annular second inner ring arranged in the second direction with respect to the first inner ring with the coupling wall interposed therebetween,

an annular second outer ring arranged in the second direction with respect to the first outer ring with the coupling wall interposed therebetween, and

a second selectable plate that is arranged in the second direction with respect to the second outer ring and that separates the second inner ring and the second outer ring from each other, wherein

a virtual plane overlapping with the coupling wall is a virtual plane,

the first inner ring and the second inner ring are formed to be plane-symmetrical with respect to the virtual plane,

the first outer ring and the second outer ring are formed to be plane-symmetrical with respect to the virtual plane,

the first selectable plate and the second selectable plate are formed to be plane-symmetrical with respect to the virtual plane,

the first outer ring, the coupling wall, and the second outer ring are coupled to each other,

the second selectable plate includes a second power transmission portion that protrudes radially outward compared to an outer peripheral surface of the second outer ring,

a side surface facing the second direction of the shift drum is a second pressing surface facing the second power transmission portion in the axial direction, and

when the shift drum moves in the second direction, the second power transmission portion is pressed in the second direction and the second selectable plate releases lifting of a second claw member arranged on an inner peripheral side of the second outer ring.

According to the selectable one-way clutch of the present disclosure, a portion to be coupled to a linear motion mechanism (first power transmission portion and shift drum) is arranged in a second direction compared to a plate body, and is reduced in size.

What is claimed is:

1. A selectable one-way clutch comprising:
a first inner ring formed in an annular shape;
a first outer ring formed in an annular shape and having the first inner ring arranged inside the first outer ring;
a shift drum formed in an annular shape and having the first inner ring and the first outer ring arranged inside the shift drum; and
a first selectable plate that separates the first inner ring and the first outer ring from each other, wherein
a direction parallel to a rotation axis of the first inner ring is an axial direction,
one side of the axial direction is a first direction,
another side of the axial direction is a second direction,
a plurality of first tooth portions are formed on one of an outer peripheral surface of the first inner ring and an inner peripheral surface of the first outer ring,
a first claw member that is tiltable and a first biasing member that biases the first claw member toward the first tooth portions are provided on the other of the outer peripheral surface of the first inner ring and the inner peripheral surface of the first outer ring,
the first selectable plate includes
an annular plate body arranged in the first direction with respect to the first outer ring, and
a first cam portion that extends in the second direction from an end portion on a radially inner side of the plate body and lifts the first claw member against biasing force of the first biasing member,
an end portion on a radially outer side of the plate body is a first power transmission portion that protrudes radially outward compared to an outer peripheral surface of the first outer ring,
a coupling portion coupled to a linear motion mechanism is formed on an outer peripheral surface of the shift drum,
a side surface of the shift drum facing the first direction is a first pressing surface facing the first power transmission portion in the axial direction, and
when the shift drum is moved in the first direction, the first power transmission portion is pressed in the first direction and lifting of the first claw member by the first cam portion is released.

2. The selectable one-way clutch according to claim 1, wherein
a groove recessed radially outward and extending in the axial direction is formed in an inner peripheral surface of the shift drum,
a protrusion portion protruding radially outward and extending in the axial direction is formed on an outer peripheral surface of the first outer ring, and
the protrusion portion is arranged in the groove, and the shift drum is movable in the axial direction and is not relatively rotatable with respect to the first outer ring.

3. The selectable one-way clutch according to claim 1, further comprising
a first coupling mechanism that couples the first outer ring and the first selectable plate, wherein
the first coupling mechanism includes
a shaft portion that penetrates the first outer ring and the first selectable plate in the axial direction,
a first retaining portion provided at an end portion in the first direction of the shaft portion,
a second retaining portion provided at an end portion in the second direction of the shaft portion, and
a first biasing member for a selectable plate,
the first biasing member for a selectable plate is arranged between the first outer ring and the second retaining portion and constantly biases the second retaining portion in the second direction, and
when pressing by the shift drum is released, the first selectable plate is pressed in the second direction by the first retaining portion.

4. The selectable one-way clutch according to claim 1, further comprising
an annular hub arranged inside the first inner ring, wherein
an annular coupling wall extending radially outward is formed on an outer peripheral surface of the hub,
the coupling wall is arranged in the second direction with respect to the first inner ring and the first outer ring, and
the first outer ring and the coupling wall are coupled in a manner of not being relatively rotatable.

5. The selectable one-way clutch according to claim 4, wherein
an annular fitting wall protruding in the second direction and surrounding an outer peripheral side of the coupling wall is formed on a side surface of the first outer ring facing the second direction,
the coupling wall is fitted into an inner peripheral side of the fitting wall, and
an outer diameter of the coupling wall is different between a shape viewed from the first direction and a shape viewed from the second direction.

6. The selectable one-way clutch according to claim 4, further comprising
an annular second inner ring arranged in the second direction with respect to the first inner ring with the coupling wall interposed therebetween,
an annular second outer ring arranged in the second direction with respect to the first outer ring with the coupling wall interposed therebetween, and
a second selectable plate that is arranged in the second direction with respect to the second outer ring and that separates the second inner ring and the second outer ring from each other, wherein
a virtual plane overlapping with the coupling wall is a virtual plane,
the first inner ring and the second inner ring are formed to be plane-symmetrical with respect to the virtual plane,
the first outer ring and the second outer ring are formed to be plane-symmetrical with respect to the virtual plane,
the first selectable plate and the second selectable plate are formed to be plane-symmetrical with respect to the virtual plane,
the first outer ring, the coupling wall, and the second outer ring are coupled to each other,
the second selectable plate includes a second power transmission portion that protrudes radially outward compared to an outer peripheral surface of the second outer ring,
a side surface facing the second direction of the shift drum is a second pressing surface facing the second power transmission portion in the axial direction, and
when the shift drum moves in the second direction, the second power transmission portion is pressed in the second direction and the second selectable plate releases lifting of a second claw member arranged on an inner peripheral side of the second outer ring.

7. The selectable one-way clutch according to claim 5, further comprising
an annular second inner ring arranged in the second direction with respect to the first inner ring with the coupling wall interposed therebetween,
an annular second outer ring arranged in the second direction with respect to the first outer ring with the coupling wall interposed therebetween, and
a second selectable plate that is arranged in the second direction with respect to the second outer ring and that separates the second inner ring and the second outer ring from each other, wherein
a virtual plane overlapping with the coupling wall is a virtual plane,
the first inner ring and the second inner ring are formed to be plane-symmetrical with respect to the virtual plane,
the first outer ring and the second outer ring are formed to be plane-symmetrical with respect to the virtual plane,
the first selectable plate and the second selectable plate are formed to be plane-symmetrical with respect to the virtual plane,
the first outer ring, the coupling wall, and the second outer ring are coupled to each other,
the second selectable plate includes a second power transmission portion that protrudes radially outward compared to an outer peripheral surface of the second outer ring,
a side surface facing the second direction of the shift drum is a second pressing surface facing the second power transmission portion in the axial direction, and
when the shift drum moves in the second direction, the second power transmission portion is pressed in the second direction and the second selectable plate releases lifting of a second claw member arranged on an inner peripheral side of the second outer ring.
